(19) United States
(12) Patent Application Publication
(10) Pub. No.: US 2010/0135141 A1
(43) Pub. Date: Jun. 3, 2010

(54) INFORMATION RECORDING MEDIUM AND METHOD FOR REPRODUCING THE INFORMATION FROM THE SAME

(75) Inventors: Tomoyasu TAKAOKA, Osaka (JP); Shigeru FURUMIYA, Hyogo (JP); Naoyasu MIYAGAWA, Hyogo (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: Panasonic Corporation, Osaka (JP)

(21) Appl. No.: 12/325,339

(22) Filed: Dec. 1, 2008

(51) Int. Cl. G11B 3/74; G11B 7/24

(52) U.S. Cl. 369/94; 369/275.3; G9B/3.102; G9B/7.14

(57) ABSTRACT

The present invention has an object of providing an optical information recording medium including three or more information layers, which allows information to be reproduced from all the information layers at high quality, and a method for reproducing information from such an information recording medium. The reflectance of a third information layer 43 is made higher than that of each of a second information layer 42 and a first information layer 41. Thus, the upper limit reproduction power of laser light 31 directed to the third information layer 43 can be made lower than that of the laser light 31 directed to each of the second information layer 42 and the first information layer 41. For reproduction, the reproduction power of each information layer is equal to or lower than the upper limit reproduction power, and a product of the reflectance and the reproduction power is substantially the same among the information layers. Thus, the information reproduction can be conducted at high quality.

### BACKGROUND OF THE INVENTION

1. Field of the Invention

The present invention relates to an information recording medium including three or more information recording layers usable for information recording/reproduction performed by laser light radiation, and a method for reproducing information from the same.

2. Description of the Related Art

When a recording layer formed, on a substrate, of a thin film of a phase-changeable recording material or the like is locally heated by laser light radiation, the recording layer can be put into states of different optical constants by varying the radiation conditions. An optical information recording medium (hereinafter, referred to as an “optical recording medium”) is used for such optical information recording, erasure, rewriting or reproduction carried out using laser light. Optical recording mediums are widely researched and developed, and made into commercial products.

On a phase-changeable optical recording medium, information is recorded by changing the state of the phase-changeable material of the recording layer between, for example, a crystalline phase and an amorphous phase by heat generated by laser light radiation. Information is reproduced by detecting the reflectance difference between the crystalline phase and amorphous phase.

Among optical recording mediums, a rewritable optical recording medium uses a phase-changeable recording material which is reversibly phase-changed for a recording layer thereof, and allows information to be erased or rewritten. In such a rewritable optical recording medium, the initial state of the recording layer is generally the crystalline phase. For recording information, laser light of high power is directed toward the recording layer to melt the recording layer, and then the recording layer is rapidly cooled Thus, a part of the recording layer irradiated with the laser light is put into the amorphous phase. For erasing information, laser light of a power lower than that used for recording is directed toward the recording layer to raise the temperature of the recording layer, and then the recording layer is slowly cooled. Thus, a part of the recording layer irradiated with the laser light is put into the crystalline phase. In addition, laser light power modulated between high power and low power may be directed toward the recording layer. Thus, while the recorded information is erased, new information can be recorded. Namely, rewriting is possible.

In order to carry out erasure or rewriting at high speed, it is necessary to change the phase from the amorphous phase to the crystalline phase in a short time. Namely, in order to realize high erasure performance in a rewritable optical recording medium, it is necessary to use a phase-changeable material having a high crystallization rate for the recording layer.

In the case of a write once optical recording medium which uses a material which is not reversibly phase-changed for a recording layer, information rewriting is impossible. On such an optical recording medium, information can be recorded only once.

Information recorded on an optical recording medium is reproduced by checking the reflectance difference between the crystalline phase and the amorphous phase. Specifically, the reflectance difference is checked by, when the optical recording medium is irradiated with laser light which is set to a certain reproduction power, detecting the intensity of the light reflected from the optical recording medium as a signal. The intensity of the reflected light is in proportion to a product of the reflectance from the optical recording medium and the reproduction power of the laser light. In general, as the intensity of the reflected light is higher, the information reproduction signal quality is higher. Therefore, the reproduction power is preferably higher.

However, for reproducing information from a recordable optical recording medium such as a rewritable optical recording medium or a write once optical recording medium, the reproduction power is set not to be too high. This is done so as not to deteriorate the signal recorded on the optical recording medium as information due to the energy of the laser light which is used to irradiate the optical recording medium (see Japanese Laid-Open Patent Publication No. 2001-14679). The degree at which signal deterioration due to reproduction is unlikely to occur is called reproduction durability. (Hereinafter, the upper limit of the reproduction power at which the signal remains non-deteriorated by reproduction is called “upper limit reproduction power”. As the reproduction durability of an optical recording medium is higher, the upper limit reproduction power of the optical recording medium is higher.)

In the meantime, various technologies are being studied in order to increase the capacity of optical recording mediums. For example, according to one technology, a rewritable optical recording medium including two information layers is used. By the laser light incident on one surface of the recording medium, information recording to, or information reproduction from, the two information layers is carried out (see Japanese Laid-Open Patent Publication No. 2000-36130; the pamphlet of International Publication 03/025922). With this technology, the recording capacity of the optical recording medium can be doubled by using two information layers.

In an optical recording medium allowing information to be recorded to, or reproduced from, two information layers by laser light incident on one surface thereof, information recording to, and reproduction from, an information layer farther from the incidence side (hereinafter, referred to as the “first information layer”) is carried out by the laser light which has passed through an information layer closer to the incidence side (hereinafter, referred to as the “second information layer”) If the transmittance of the second information layer is low, the energy of the laser light reaching the first information layer is attenuated. Therefore, the reflectance from the first information layer is substantially reduced, which deteriorates the reproduction quality. For the same reason, the laser power required to carry out preferable recording on the first information layer is increased. When the power exceeds the limit of the recording apparatus, preferable recording cannot be realized, and the recording quality is deteriorated.

Accordingly, it is preferable that the second information layer has a maximum possible transmittance. In order to realize an optical recording medium having an increased number of information layers, for example, three or four information layers, in order to raise the capacity, it is necessary to further increase the transmittance of the information layers on the incidence side (third information layer or fourth information layer). Especially, it is preferable that an information layer closest to the laser light incidence side has a maximum possible transmittance because light passes through this information layer in order to record information to, or reproduce information from, an information layer farther from the laser incidence side. In general, recording materials have a large extinction coefficient. Therefore, the recording layer of the information layer on the laser light incidence side is preferably thin in order to have a high transmittance.

However, generally in the case of a rewritable optical recording medium, as the recording layer formed of a phase-changeable material is thinner, the crystallization rate thereof is decreased. Hence, the phase change from the amorphous phase to the crystalline phase is unlikely to occur, and the information erasure performance is deteriorated. For this reason, occasionally, the recording layer of the information layer closer to the laser light incidence side is formed of a phase-changeable material which is crystallized more rapidly, as well as being made thinner, than the recording layer of the information layer farther from the laser light incidence side. However, when the crystallization rate is increased, the reproduction durability is declined. Hence, the crystallization rate should not be too high.

In the case of a recordable optical recording medium including a plurality of information layers, for reproducing information from an information layer far from the laser light incidence side, the laser light used to irradiate the information layer, which is the reproduction target, passes through at least one information layer before reaching the reproduction target and so the energy of the laser light is attenuated. By contrast, for reproducing information from the information layer closest to the laser light incidence side, the energy of the laser light used to irradiate the information layer is not attenuated. Therefore, the information layer closest to the laser light incidence side is likely to cause signal deterioration by reproduction, which tends to make it difficult to improve the reproduction durability.

This tendency regarding the reproduction durability is applicable both to a rewritable optical recording medium and a write once optical recording medium. In the case of a rewritable optical recording medium, improvement of the erasure performance is also required, as described above. It is necessary to adjust the recording layer or the like so as to provide both of good erasure performance and good reproduction durability.

However, in a recordable optical recording medium, where the recording layer included in the information layer is too thin, the characteristics of the information layer are declined. For example, in the case of a rewritable optical recording medium, where the recording layer is too thin, it is difficult to provide both of good erasure performance and good reproduction durability. For this reason, in an optical recording medium including three or more information layers, there is a problem that information reproduction cannot be conducted at high quality from an information layer closest to the laser light incidence side, which is required to have a high transmittance.

### SUMMARY OF THE INVENTION

The present invention for solving the above-described problems has an object of providing an optical information recording medium including three or more information layers, which allows information to be reproduced from all the information layers at high quality, and a method for reproducing information from such an information recording medium.

In order to achieve the above objectives, an information recording medium according to the present invention comprises N number (N is an integer fulfilling N≧3) of information layers on which information is recordable, and allows information to be recorded to, or reproduced from, each of the information layers by being irradiated with laser light. Where the N number of information layers include an Nth information layer, an (N−1)th information layer, an (N−2)th information layer, . . . a second information layer and a first information layer from the side on which the laser light is incident, the Nth information layer has a reflectance of R_{N}, an Mth information layer (M is an integer fulfilling N>M≧1) has a reflectance of R_{M}, the laser light used to irradiate the Nth information layer at the time of information reproduction has an upper limit reproduction power of Pr_{Nmax}, and the laser light used to irradiate the Mth information layer at the time of information reproduction has an upper limit reproduction power of Pr_{Mmax}, the following expressions (1) and (2) are concurrently fulfilled:

R_{N}>R_{M} (1)

Pr_{Nmax}<Pr_{Mmax} (2).

An information recording medium reproducing method according to the present invention is for reproducing information from the information recording medium. The method comprises an Nth information layer reproducing method for reproducing information recorded on the Nth information layer at a reproduction power of Pr_{N} (Pr_{N}≦Pr_{Nmax}), and an (N−1)th information layer reproducing method for reproducing information recorded on the (N−1)th information layer at a reproduction power of Pr_{N-1} (Pr_{N-1}≦Pr_{N-1max}). A product R_{N}×Pr_{N} of the reflectance R_{N} and the reproduction power Pr_{N} of the Nth information layer is substantially equal to a product R_{N-1}×Pr_{N-1} of the reflectance R_{N-1} and the reproduction power Pr_{N-1} of the (N−1)th information layer.

According to an information recording medium of the present invention, the reflectance of the Nth information layer is made high. Owing to this, even if the reproduction power of the Nth information layer is low, high quality information reproduction is realized from the Nth information layer. In accordance with this, the upper limit reproduction power of the Nth information layer is made lower than the upper limit reproduction power of the other information layers. Owing to this, the transmittance of the Nth information layer is can be made higher than in the conventional art. Thus, high quality information reproduction can be realized from all of the first information layer through the (N−1)th information layer.

According to an information recording medium reproducing method of the present invention, a product of the reflectance and the reproduction power of the Nth information layer is made equal to a product of the reflectance and the reproduction power of the (N−1)th information layer. Thus, information can be reproduced from the Nth information layer at high quality with no deterioration.

### BRIEF DESCRIPTION OF THE DRAWINGS

FIG. 1 is a cross-sectional view of an example of a structure of an information recording medium according to the present invention.

FIG. 2 is a cross-sectional view of an example of a structure of an information recording medium according to the present invention.

FIG. 3 is a schematic view showing an example of a recording/reproducing apparatus for an information recording medium according to the present invention.

FIG. 4 is a schematic view showing an example of a recording pulse waveform usable for recording to, or reproduction from, an information recording medium according to the present invention.

### DETAILED DESCRIPTION OF PREFERRED EMBODIMENTS

Hereinafter, embodiments of the present invention will be described with reference to the drawing. The following embodiments are merely examples, and the present invention is not limited to these embodiments. In the following embodiments, identical elements bear identical reference numerals and the repetition of the same description may be omitted.

### Embodiment 1

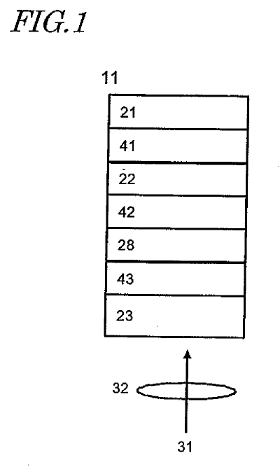

In Embodiment 1, an example of an information recording medium according to the present invention will be described. FIG. 1 shows a partial cross-sectional view of an information recording medium 11 according to Embodiment 1. The information recording medium 11 is a three-layer optical recording medium which allows information to be recorded thereto or reproduced therefrom when being irradiated with laser light 31 collected by an objective lens 32.

As the wavelength λ of the laser light 31 is shorter, the spot formed by the laser light 31 collected by the objective lens 32 has a shorter diameter. Where the wavelength λ is too short, a large amount of the laser light 31 is absorbed to a transparent layer 23 or the like. For this reason, the wavelength λ of the laser light is preferably in the range of 350 nm to 450 nm.

The information recording medium 11 includes three information recording layers, i.e., a first information layer 41, a second information layer 42, and a third information layer 43, and a transparent layer 23 which are provided on a substrate 21 in this order. The first information layer 41, the second information layer 42 and the third information layer 43 are sequentially stacked with separating layers 22 and 28 being interposed therebetween.

The laser light 31 is collected by the objective lens 32 and directed to each information layer of the information recording medium 11 from the side of the transparent layer 23. Thus, information recording or reproduction is carried out.

In the information recording medium 11, the laser light reaching any information layer closer to the substrate 21 than the third information layer 43, or light reflected by such an information layer, is attenuated because such light has already transmitted through an information layer(s) which is(are) closer to the laser light 31 incidence side than said any information layer. Therefore, the first information layer 41 and the second information layer 42 need to have a high recording sensitivity and a high reflectance. The second information layer 42 and the third information layer 43 need to have a high transmittance.

The substrate 21 is shaped like a discus, and is used for holding the layers from the first information layer 41 to the transparent layer 23. In a surface of the substrate 21 facing the first information layer 41, a guide groove may be formed to guide the laser light 31. A surface of the substrate 21 not facing the first information layer 41 is preferably smooth. Materials usable for the substrate 21 include, for example, polycarbonate resins, polymethylmethacrylate resins, polyolefin resins, norbornene-based resins, glass, and any appropriate combination thereof. Especially, polycarbonate resins are superb in transferability and mass-producibility and available at low cost, and so are preferable as a material for the substrate 21.

The separation layers 22, 28, etc. are provided so that the focusing positions in the first information layer 41, the second information layer 42 and the third information layer 43 of the information recording medium 11 are distinguishable from each other. The separation layers 22 and 28 preferably have a thickness which is equal to or greater than the focus depth determined by the numerical aperture NA of the objective lens 32 and the wavelength λ of the laser light 31. Where the separation layers 22 and 28 are too thick, the distance from the laser light 31 incidence side to the first information layer 41 of the information recording medium 11 is too long. This enlarges the coma aberration when the disc is tilted, and the laser light 31 cannot be accurately collected to the first information layer 41. From this viewpoint, it is preferable that the separation layers 22 and 28 are thin. Where λ=405 nm and NA=0.85, the thickness of the separation layers 22 and 28 is preferably in the range of 5 μm to 50 μm.

It is preferable that the separation layers 22 and 28 do not absorb much of the laser light 31. In a surface of each of the separation layers 22 and 28 facing the laser light 31 incidence side, a guide groove for guiding the laser light 31 may be formed. Materials usable for the separation layers 22 and 28 include, for example, are polycarbonate resins, polymethylmethacrylate resins, polyolefin resins, norbornene-based resins, UV curable resins, delayed-action thermosetting resins, glass, and any appropriate combination thereof.

The transparent layer 23 is provided on the laser light 31 incidence side of the third information layer 43 and protects the third information layer 43. It is preferable that the transparent layer 23 does not absorb much of the laser light 31. Materials usable for the transparent layer 23 include, for example, are polycarbonate resins, polymethylmethacrylate resins, polyolefin resins, norbornene-based resins, UV curable resins, delayed-action thermosetting resins, glass, and any appropriate combination thereof. A sheet formed of such a material may be used as the transparent layer 23.

Where the transparent layer 23 is too thin, the function of protecting the third information layer 43 is not provided. Where the transparent layer 23 is too thick, the distance from the laser light 31 incidence side to the first information layer 41 of the information recording medium 11 is too long as in the case of the separation layers 22 and 28. This enlarges the coma aberration when the disc is tilted, and the laser light 31 cannot be accurately collected to the first information layer 41. Where NA=0.85, the thickness of the transparent layer 23 is preferably in the range of 5 μm to 150 μm, and more preferably in the range of 40 μm to 110 μm.

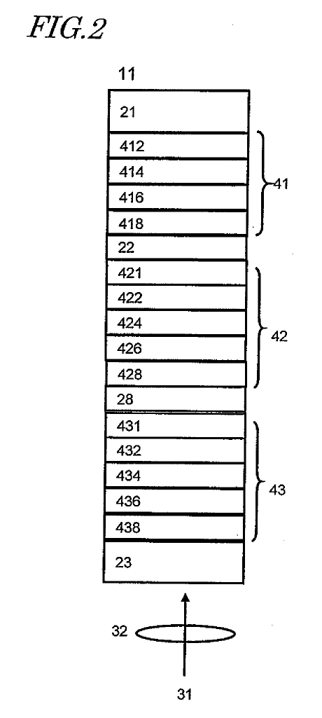

FIG. 2 shows each of the layers shown in FIG. 1 in more detail.

As shown in FIG. 2, the first information layer 41 includes a reflection layer 412, a first dielectric layer 414, a recording layer 416 and a second dielectric layer 418 provided in this order from the side closer to the substrate 21. Optionally, a reflection layer side interface layer 413 may be provided between the reflection layer 412 and the first dielectric layer 414. A first interface layer 415 may be provided between the first dielectric layer 414 and the recording layer 416. A second interface layer 417 may be provided between the second dielectric layer 418 and the recording layer 416 (the reflection layer side interface layer, the first interface layer and the second interface layer are omitted from the figure).

Similarly, the second information layer 42 includes a transmittance adjusting layer 421, a reflection layer 422, a first dielectric layer 424, a recording layer 426 and a second dielectric layer 428 provided in this order from the side closer to the substrate 21. Optionally, a reflection layer side interface layer 423 may be provided between the reflection layer 422 and the first dielectric layer 424. A first interface layer 425 may be provided between the first dielectric layer 424 and the recording layer 426. A second interface layer 427 may be provided between the second dielectric layer 428 and the recording layer 426 (the reflection layer side interface layer 423, the first interface layer 425 and the second interface layer 427 are omitted from the figure).

Similarly, the third information layer 43 includes a transmittance adjusting layer 431, a reflection layer 432, a first dielectric layer 434, a recording layer 436 and a second dielectric layer 438 provided in this order from the side closer to the substrate 21. Optionally, a reflection layer side interface layer 433 may be provided between the reflection layer 432 and the first dielectric layer 434. A first interface layer 435 may be provided between the first dielectric layer 434 and the recording layer 436. A second interface layer 437 may be provided between the second dielectric layer 438 and the recording layer 436 (the reflection layer side interface layer 433, the first interface layer 435 and the second interface layer 437 are omitted from the figure).

Now, each layer included in the first information layer 41 will be described.

The recording layer 41 is reversibly phase-changeable between a crystalline phase and an amorphous phase when being irradiated with the laser light 31. A material usable for the recording layer 416 contains any one of (Ge—Sn)Te, GeTe—Sb₂Te₃, (Ge—Sn)Te—Sb₂Te₃, GeTe—Bi₂Te₃, (Ge—Sn)Te—Bi₂Te₃, GeTe—(Sb—Bi)₂Te₃, (Ge—Sn)Te—(Sb—Bi)₂Te₃, GeTe—(Si—In)₂Te₃, (Ge—Sn)Te—(Bi—In)₂Te₃, Sb—Te, Sb—Ge, (Gb—Te)—Ge, Sb—In, (Sb—Te)—In, Sb—Ga and (Sb—Te)—Ga. It is preferable that the recording layer 416 in the amorphous phase is easily changeable to the crystalline phase by being irradiated with the laser light during recording and is not easily changeable to the crystalline phase when not being irradiated with laser light.

Where the recording layer 416 is too thin, none of a sufficient reflectance, reflectance change rate and erasability is provided; whereas where the recording layer 416 is too thick, the thermal capacity is too large and so the recording sensitivity is reduced. Therefore, the thickness of the recording layer 416 is preferably in the range of 5 nm to 15 nm, and more preferably in the range of 8 nm to 12 nm.

The reflection layer 412 has an optical function of increasing the amount of light absorbed to the recording layer 416 and a thermal function of diffusing the heat generated in the recording layer 416. A material usable for the reflection layer 412 contains at least one element selected from Ag, Au, Cu and Al. For example, an alloy such as Ag—Cu, Ag—Ga—Cu, Ag—Pd—Cu, Ag—Nd—Au, AlNi, AlCr, Au—Cr or Ag—In is usable. Especially, an alloy of Ag has a high thermal conductivity and so is preferable as a material of the reflection layer 412. As the reflection layer 412 is thicker, the thermal diffusion function thereof is higher. However, where the reflection layer 412 is too thick, the thermal diffusion function is too high and reduces the recording sensitivity of the recording layer 416. Therefore, the thickness of the reflection layer 412 is preferably in the range of 30 nm to 200 nm, and more preferably in the range of 70 nm to 140 nm.

The first dielectric layer 414 is located between the recording layer 416 and the reflection layer 412. The first dielectric layer 414 has a thermal function of adjusting the thermal diffusion from the recording layer 416 to the reflection layer 412 and an optical function of adjusting the reflectance, the absorptivity and the like of the reflection layer 412 and the recording layer 416. Materials usable for the first dielectric layer 414 include, for example, oxides such as ZrO₂, HfO₂, ZnO, SiO₂, SnO₂, Cr₂O₃, TiO₂, In₂O₃, Ga₂O₃, Y₂O₃, CeO₂, DyO₂ and the like; sulfides such as ZnS, CdS and the like; single-element carbides such as SiC and the like; and mixtures thereof. Such mixtures include, for example, ZrO₂—SiO₂, ZrO₂—SiO₂—Cr₂O₃, ZrO₂—SiO₂—Ga₂O₃, HfO₂—SiO₂—Cr₂O₃, ZrO₂—SiO₂—In₂O₃, ZnS—SiO₂, and SnO₂—SiC. Especially, ZnS—SiO₂ is superb as a material of the first dielectric layer 414 because ZnS—SiO₂ is formed into a film at high speed, is transparent, and has good mechanical characteristics and good moisture resistance.

Where the first dielectric layer 414 is too thick, the cooling effect on the reflection layer 412 is too weak. This excessively decreases the thermal diffusion from the recording layer 416 and makes it difficult for the recording layer 416 to be changed into the amorphous phase. Where the first dielectric layer 414 is too thin, the cooling effect on the reflection layer 412 is too strong. This excessively increases the thermal diffusion from the recording layer 416 and reduces the sensitivity of the recording layer 416. Therefore, the thickness of the first dielectric layer 414 is preferably in the range of 2 nm to 40 nm, and more preferably in the range of 8 nm to 30 nm.

The reflection layer side interface layer 413 acts to prevent the material of the first dielectric layer 414 from corroding or destroying the reflection layer 412. Specifically, where the reflection layer 412 is formed of a material containing Ag and the first dielectric layer 414 is formed of a material containing S (e.g., ZnS—SiO₂), the reflection layer side interface layer 413 prevents Ag from being corroded by reaction with S.

A material usable for the reflection layer side interface layer 413 is a metal material other than Ag, for example, Al or an Al alloy.

Other materials usable for the reflection layer side interface layer 413 include dielectric materials not containing S, for example, oxides such as ZrO₂, HfO₂, ZnO, SiO₂, SnO₂, Cr₂O₃, TiO₂, In₂O₃, Ca₂O₃, Y₂O₃, CeO₂, DyO₂ and the like; single-element carbides such as SiC and the like; and mixtures thereof. Such mixtures include, for example, ZrO₂—SiO₂, ZrO₂—SiO₂—Cr₂O₂, ZrO₂—SiO₂—Ga₂O₂, HfO₂—SiO₂—Cr₂O₃, ZrO₂—SiO₂—In₂O₃, and SnO₂—SiC. C or the like is also usable.

Where the reflection layer side interface layer 413 is too thick, the reflection layer side interface layer 413 obstructs the thermal and optical functions of the first dielectric layer 414. Where the reflection layer side interface layer 413 is too thin, the function of preventing the corrosion or the destruction of the reflection layer 414 is declined. Therefore, the thickness of the reflection layer side interface layer 413 is preferably in the range of 1 nm to 100 nm, and more preferably in the range of 5 nm to 40 nm.

The first interface layer 415 acts to prevent substance migration between the first dielectric layer 414 and the recording layer 416, which would otherwise be caused by the recording being conducted in repetition. The first interface layer 415 is preferably formed of a material which has such a melting point sufficiently high to protect the first interface layer 415 from being melted at the time of recording and has good adhesion with the recording layer 416. Materials usable for the first interface layer 415 include, for example, oxides such as ZrO₂, HfO₂, ZnO, SiO₂, SnO₂, Cr₂O₃, TiO₂, In₂O₃, Ga₂O₃, Y₂O₃, CeO₂, DyO₂ and the like; sulfides such as ZnS, CdS and the like; single-element carbides such as SiC and the like; and mixtures thereof. Such mixtures include, for example, ZrO₂—SiO₂, ZrO₂—SiO₂—Cr₂O₃, ZrO₂—SiO₂—Ga₂O₃, HfO₂—SiO₃—Cr₂O₃, ZrO₂—SiO₂—In₂O₃, ZnS—SiO₂, and SnO₂—SiC. C or the like is also usable. Especially, Ga₂O₃, ZnO and In₂O₃, for example, are preferable as a material of the first interface layer 415 because of good adhesion thereof with the recording layer 416.

Where the first interface layer 415 is too thin, the effect as an interface layer cannot be provided. Where the first interface layer 415 is too thick, the first interface layer 415 obstructs the thermal and optical functions of the first dielectric layer 414. Therefore, the thickness of the first interface layer 415 is preferably in the range of 0.3 nm to 15 nm, and more preferably in the range of 1 nm to 8 nm.

The second dielectric layer 418 is located on the layer light 31 incidence side of the recording layer 416, and has a function of preventing the recording layer 416 from being corroded or deformed and an optical function of adjusting the reflectance, the absorptivity and the like of the recording layer 416. Materials usable for the second interface layer 418 are substantially the same as those for the first dielectric layer 414. Especially, ZnS—SiO₂ is superb as a material of the second dielectric layer 418 because ZnS—SiO₂ is formed into a film at high speed, is transparent, and has good mechanical characteristics and good moisture resistance.

Where the second dielectric layer 418 is too thin, the function of preventing the recording layer 416 from being corroded or deformed is declined. The thickness of the second dielectric layer 418 can be precisely determined by a calculation based on the Matrix Method so as to fulfill the conditions for increasing the change of the amount of light reflected by the recording layer 416 between where the recording layer 416 is in the crystalline phase and where the recording layer 416 is in the amorphous phase. The thickness of the second dielectric layer 418 is preferably in the range of 20 nm to 80 nm.

The second interface layer 417, like the first interface layer 415, acts to prevent substance migration between the second dielectric layer 418 and the recording layer 416, which would otherwise be caused by the recording being conducted in repetition. Therefore, the second interface layer 417 is preferably formed of a material which has substantially the same performances as those of the first interface layer 415.

The thickness of the second interface layer 417 is preferably in the range of 0.3 nm to 15 nm, and more preferably in the range of 1 nm to 8 nm, like the first interface layer 415.

The information layer 41 is formed of the reflection layer 412, the first dielectric layer 414, the recording layer 416 and the second dielectric layer 418, and optionally the reflection side interface layer 413, the first interface layer 415 and the second interface layer 417.

Now, each layer included in the second information layer 42 will be described.

Materials usable for the recording layer 426 are substantially the same as those usable for the first recording layer 416 of the first information layer 41. The thickness of the first recording layer 426 is preferably 10 nm or less, and more preferably in the range of 4 nm to 8 nm, in order to increase the transmittance of the second information layer 42.

The reflection layer 422 has substantially the same functions as those of the reflection layer 412 of the first information layer 41. Namely, the reflection layer 422 has an optical function of increasing the amount of light absorbed to the recording layer 426 and a thermal function of diffusing the heat generated in the recording layer 426. Therefore, materials usable for the reflection layer 422 are substantially the same as those usable for the reflection layer 412 of the first information layer 41. Especially, an alloy of Ag has a high thermal conductivity and so is preferable as a material of the reflection layer 422.

The thickness of the reflection layer 422 is preferably 20 nm or less, and more preferably in the range of 3 nm to 14 nm, in order to increase the transmittance of the second information layer 42. Since the thickness of the reflection layer 422 is in this range, the optical and thermal functions of the reflection layer 422 are sufficiently provided.

The first dielectric layer 424 has substantially the same functions as those of the first dielectric layer 414 of the first information layer 41. Namely, the first dielectric layer 424 has a thermal function of adjusting the thermal diffusion from the recording layer 426 to the reflection layer 422 and an optical function of adjusting the reflectance, the absorptivity and the like of the reflection layer 422 and the recording layer 426. Therefore, materials usable for the first dielectric layer 424 are substantially the same as those usable for the first dielectric layer 414 of the first information layer 41.

The thickness of the first dielectric layer 424 is preferably in the range of 1 nm to 40 nm, and more preferably in the range of 4 nm to 30 nm, in order to provide the optical and thermal functions thereof sufficiently.

The second dielectric layer 428 has substantially the same functions as those of the second dielectric layer 418 of the first information layer 41. Namely, the second dielectric layer 428 has a function of preventing the recording layer 426 from being corroded or deformed and an optical function of adjusting the reflectance, the absorptivity and the like of the recording layer 426. Therefore, materials usable for the second dielectric layer 428 are substantially the same as those usable for the second dielectric layer 418 of the first information layer 41. The thickness of the second dielectric layer 428 can be precisely determined by a calculation based on the Matrix Method so as to fulfill the conditions for increasing the change of the amount of light reflected by the recording layer 426 between where the recording layer 426 is in the crystalline phase and where the recording layer 426 is in the amorphous phase.

The transmittance adjusting layer 421 is formed of a dielectric material and has a function of adjusting the transmittance of the second information layer 42. Owing to the transmittance adjusting layer 421, the transmittance Tc (%) of the second information layer 42 where the recording layer 426 is in the crystalline phase and the transmittance Ta (%) of the second information layer 42 where the recording layer 426 Is in the amorphous phase can both be improved.

Material usable for the transmittance adjusting layer 421 include, for example, oxides such as TiO₂, ZrO₂, HfO₂, ZnO, Nb₂O₅, Ta₂O₅, Al₂O₃, SiO₂, Cr₂O₃, CeO₂, Ga₂O₃, Bi₂O₃ and the like; nitrides such as Ti—N, Zr—N, Nb—N, Ge—N, Cr—N, Al—N and the like; single-element sulfides such as ZnS; and mixtures thereof. The refractive index nₜ and the extinction coefficient kₜ of the transmittance adjusting layer 421 preferably have the relationships of nₜ≧2.4 and kₜ≦0.1. Therefore, it is preferable to use TiO₂ or a material containing TiO₂ among the above-listed materials, for the following reason. Since such a material has a large refractive index (nₜ=2.6 to 2.8) and a small extinction coefficient (kₜ=0.0 to 0.1), the transmittance adjusting layer 421 formed of such a material effectively improves the transmittance of the second information layer 42.

Where the thickness of the transmittance adjusting layer 421 is approximately λ8nₜ (where λ is the wavelength of the laser light 31 and nₜ is the refractive index of the material of the transmittance adjusting layer 491), the effect of improving the transmittance Tc and the transmittance Ta is significant. Where λ=405 nm and nₜ=2.6, the thickness of the transmittance adjusting layer 491 is preferably in the range of 5 nm to 36 nm in consideration of other conditions including the reflectance and the like).

The reflection layer side interface layer 423, the first interface layer 425 and the second interface layer 427 respectively have substantially the same functions and may be formed of substantially the same materials as those of the reflection layer side interface layer 413, the first interface layer 415 and the second interface layer 417 of the first information layer 41.

Now, each layer included in the third information layer 43 will be described.

The layers included in the third information layer 43 have substantially the same functions and may be formed of substantially the same materials as those of the corresponding layers included in the second information layer 42, respectively.

The information recording medium 11 can be produced by a method described below.

First, the first information layer 41 is stacked on the substrate 21 (thickness: e.g., 1.1 mm). The first information layer 41 is formed of a plurality of layers, each of which can be sequentially formed by sputtering. The substrate 21 may have a high moisture absorptivity depending on the material thereof. Therefore, a substrate annealing step of removing the moisture may be carried out before the sputtering.

Each layer can be formed by sputtering a sputtering target of the material used to form the respective layer in an atmosphere of a noble gas such as Ar gas, Kr gas, Xe gas or the like or a mixed gas atmosphere of a noble gas and a reactive gas (at least one type of gas selected from oxygen gas and nitrogen gas). As the sputtering method, either DC sputtering or RF sputtering, whichever is suitable for a respective occasion, is optionally selected. Usually, DC sputtering, which increases the film formation rate, is preferable. However, some materials such as dielectric materials and the like having a low conductivity may not be sputtered by DC sputtering. Such materials are sputtered by RE sputtering. A dielectric material having a high conductivity or a dielectric material treated to have an improved conductivity during the formation of the sputtering target can be sputtered by DC sputtering or pulse DC sputtering.

The composition of each layer formed by sputtering may not completely match the original composition of the sputtering target. For example, an oxide is likely to lose some oxygen as a result of sputtering. Such a loss of oxygen can be compensated for by using oxygen gas as a reactive gas. The composition of the sputtering target is determined such that the layer formed by sputtering can have a desired composition. The compositions of the sputtering target and the layer formed by sputtering can be checked by analysis using, for example, an X-ray microanalyzer.

The information recording medium 11 is specifically produced as follows. First, the reflection layer 412 is formed on the substrate 21. The reflection layer 412 can be formed by DC-sputtering a sputtering target formed of a metal or an alloy to be used for the reflection layer 412 in a noble gas atmosphere or a mixed gas atmosphere of a noble gas and a reactive gas.

Next, the reflection layer side interface layer 413 is optionally formed on the reflection layer 412. The reflection layer side interface layer 413 can be formed by sputtering a sputtering target formed of a material to be used for the reflection layer side interface layer 413 in a noble gas atmosphere or a mixed gas atmosphere of a noble gas and a reactive gas. In the case where the material for the reflection layer side interface layer 413 is a metal or any other material having a high conductivity, DC sputtering may be used; whereas in the case where the material for the reflection layer side interface layer 413 is an oxide or any other material having a low conductivity, RF sputtering may be used.

Next, the first dielectric layer 414 is formed on the reflection layer side interface layer 413 or the reflection layer 412. The first dielectric layer 414 can be formed by sputtering a sputtering target formed of a material to be used for the first dielectric layer 414 in a noble gas atmosphere or a mixed gas atmosphere of a noble gas and a reactive gas, mainly using RF sputtering. RF sputtering is used because most of the materials usable for the first dielectric layer 414 have a low conductivity and DC sputtering is not suitable.

Next, the first interface layer 415 is optionally formed on the first dielectric layer 414. The first interface layer 415 can be formed by sputtering a sputtering target formed of a material to be used for the first interface layer 415 in a noble gas atmosphere or a mixed gas atmosphere of a noble gas and a reactive gas, mainly using RF sputtering.

Next, the recording layer 416 is formed on the first interface layer 415 or the first dielectric layer 414. The recording layer 416 can be formed by sputtering a sputtering target formed of a material to be used for the recording layer 416 in a noble gas atmosphere, mainly using DC sputtering.

Next, the second interface layer 417 is optionally formed on the recording layer 416. The second interface layer 417 can be formed by sputtering a sputtering target formed of a material to be used for the second interface layer 417 in a noble gas atmosphere or a mixed gas atmosphere of a noble gas and a reactive gas, mainly using RF sputtering.

Next, the second dielectric layer 418 is formed on the second interface layer 417 or the recording layer 416. The second dielectric layer 418 can be formed by sputtering a sputtering target formed of a material to be used for the second dielectric layer 418 in a noble gas atmosphere or a mixed gas atmosphere of a noble gas and a reactive gas, mainly using RF sputtering.

The first information layer 41 is stacked on the substrate 21 in this manner, and then the separation layer 22 is formed on the first information layer 41. The separation layer 22 can be formed as follows. A UV curable resin (e.g., an acrylic-based resin or an epoxy-based resin) or a delayed-action thermosetting resin is applied to the information layer. The entirety of the resultant body is rotated to uniformly extend the resin on the information layer (spin-coating), and then the resin is cured. In the case where the separation layer 22 is to have a guide groove for the laser light 31, the guide groove can be formed as follows. A substrate (pattern substrate) having a groove therein is closely attached to the pre-curing resin, and the entirety of the assembly is rotated for spin-coating. After the resin is cured, the substrate (pattern substrate) is removed.

The recording layer 416 of the first information layer 41 is usually in an amorphous state when being formed (as-depo state). Therefore, an initialization step of crystallizing the recording layer 416 may be optionally carried out by, for example, irradiating the recording layer 416 with laser light.

Next, the second information layer 42 is formed on the separation layer 22.

Specifically, first, the transmittance adjusting layer 421 is formed on the separation layer 22. The transmittance adjusting layer 421 can be formed by sputtering a sputtering target formed of a material to be used for the transmittance adjusting layer 421 in a noble gas atmosphere or a mixed gas atmosphere of a noble gas and a reactive gas, using RF sputtering or DC sputtering.

Next, the reflection layer 422 is formed on the transmittance adjusting layer 421. The reflection layer 422 can be formed in substantially the same manner as the reflection layer 412 of the first information layer 41.

Next, the reflection layer side interface layer 423 is optionally formed on the reflection layer 422. The reflection layer side interface layer 423 can be formed in substantially the same manner as the reflection layer side interface layer 413 of the first information layer 41.

Next, the first dielectric layer 424 is formed on the reflection layer side interface layer 423 or the reflection layer 422. The first dielectric layer 424 can be formed in substantially the same manner as the first dielectric layer 414 of the first information layer 41.

Next, the first interface layer 425 is optionally formed on the first dielectric layer 424. The first interface layer 425 can be formed in substantially the same manner as the first interface layer 415 of the first information layer 41.

Next, the recording layer 426 is formed on the first interface layer 425 or the first dielectric layer 424. The recording layer 426 can be formed in substantially the same manner as the recording layer 416 of the first information layer 41.

Next, the second interface layer 427 is optionally formed on the recording layer 426. The second interface layer 427 can be formed in substantially the same manner as the second interface layer 417 of the first information layer 41.

Next, the second dielectric layer 428 is formed on the second interface layer 427 or the recording layer 426. The second dielectric layer 428 can be formed in substantially the same manner as the second dielectric layer 418 of the first information layer 41.

The second information layer 42 is stacked on the separation layer 22 in this manner, and then the separation layer 28 is formed on the second information layer 42. The separation layer 28 can be formed in substantially the same manner as the separation layer 22.

After the second dielectric layer 428 is formed or after the separation layer 28 is formed, an initialization step of crystallizing the recording layer 426 may be optionally carried out by, for example, directing the laser light.

Next, the third information layer 43 is formed on the separation layer 28.

Specifically, the transmittance adjusting layer 431, the reflection layer 432, the first dielectric layer 434, the recording layer 436 and the second dielectric layer 438 are formed on the separation layer 28 in this order. Optionally, the reflection layer side interface layer 433 may be formed between the reflection layer 432 and first dielectric layer 434. The first interface layer 435 may be formed between the first dielectric layer 434 and the recording layer 436. The second interface layer 437 may be formed between the second dielectric layer 438 and the recording layer 436. These layers can each be formed in substantially the same manner as the corresponding layer of the second information layer 42.

The third information layer 43 is formed on the separation layer 28 in this manner, and then the transparent layer 23 is formed on the third information layer 43.

The transparent layer 23 can be formed as follows. A UV curable resin (e.g., an acrylic-based resin or an epoxy-based resin) or a delayed-action thermosetting resin is applied to the third information layer 43, spin-coated, and cured. Alternatively, the transparent layer 23 may be formed by use of a discus-shaped plate or sheet formed of a polycarbonate resin, a polymethylmethacrylate resin, a polyolefin resin, a norbornene-based resin, glass or the like. In this case, the transparent layer 23 can be formed as follows. A UV curable resin or a delayed-action thermosetting resin is applied to the third information layer 43. After the plate or sheet is closely attached to the applied resin, the resin is spin-coated. Then, the UV curable resin or the delayed-action thermosetting resin is cured. According to another method, a viscous resin is uniformly applied to the plate or sheet, and then the plate or sheet is closely attached to the second dielectric layer 438.

After the second dielectric layer 438 is formed or after the transparent layer 23 is formed, an initialization step of crystallizing the recording layer 426 may be optionally carried out by, for example, directing the laser light.

In this manner, the information recording layer 11 can be produced. In this embodiment, sputtering is used for forming each of the layers included in the information layers. The present invention is not limited to this, and vacuum vapor deposition, ion plating, MBE (Molecular Beam Epitaxy) or the like is also usable.

In this embodiment, the information recording medium 11 including three information layers is described. An information recording medium including four or more information layers can be produced in substantially the same method.

In this embodiment, the recording layers 416, 426 and 436 are reversibly phase-changeable between the crystalline phase and the amorphous phase, and so the information recording medium 11 is a rewritable optical recording medium. The information recording medium 11 may be a write once optical recording medium. In such a case, the recording layers 416, 426 and 436 may be irreversibly phase-changeable. A material usable for an irreversibly phase-changeable layer is, for example, Te—O—Pd or the like. In such a case, the thickness of the recording layer 416 of the first information layer 41 is preferably in the range of 10 nm to 50 nm, and the thickness of each of the recording layer 426 of the second information layer 42 and the recording layer 436 of the third information layer 43 is preferably in the range of 6 nm to 30 nm.

### Embodiment 2

In Embodiment 2, an example of a method for recording information to, or reproducing information from, the information recording medium 11 described in Embodiment 1 will be described.

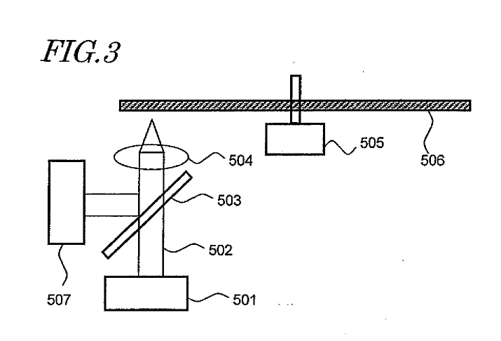

FIG. 3 is a schematic view showing an example of a structure of a recording/reproducing apparatus for recording information to, or reproducing information from, an information recording medium according to the present invention. Laser light 502 from a laser diode 501 passes through a half mirror 503 and objective lens 504 and is focused on an information recording medium 506 rotated by a motor 505. Information is reproduced by causing light reflected from the information recording medium 506 to be incident on a photodetector 507 and detecting a signal. A power of the laser light 502 for detecting the signal is set to be equal to or lower than an upper limit reproduction power in order to prevent the signal from being deteriorated by the reproduction. For detecting the signal, the laser light 502 may occasionally superimpose a high frequency current on a driving current for the laser diode 501.

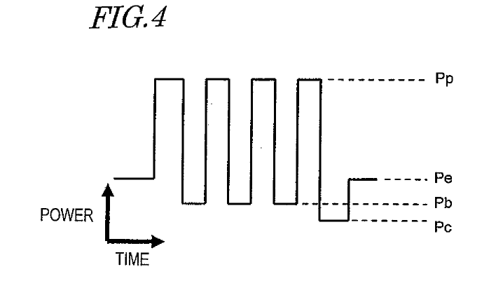

For recording an information signal, the intensity of the laser light 502 is modulated among a plurality of power levels. As means for modulating the laser intensity, current modulation means for modulating a driving current for a semiconductor laser is usable. For forming a recording mark, a single rectangular pulse having a peak power of Pp is usable. For forming an especially long mark, a recording pulse stream including a plurality of pulse streams modulated between the peak power Pp and a bottom power Pb (Pp>Pb) as shown in FIG. 4 is usable in order to eliminate extra heat and make the mark widths uniform. After the final pulse, a cooling zone of a cooling power Pc may be provided. For a part in which no mark is to be formed, the intensity is kept constant at a bias power Pe (Pp>Pe).

The objective lens 504 preferably has a numerical aperture NA in the range of 0.5 to 1.1, and more preferably in the range of 0.6 to 0.9, in order to adjust the spot diameter of the laser light 502 to the range of 0.4 μm to 0.7 μm. The laser light 502 preferably has a wavelength λ in the range of 350 nm to 450 nm. A linear velocity of the information recording medium 506 for recording information is preferably in the range of 3 m/s to 40 m/s at which recrystallization is unlikely to occur and a sufficient level of erasure performance is obtained, and more preferably in the range of 6 m/s to 30 m/s. Needless to say, the wavelength, the numerical aperture of the objective lens and the linear velocity may be of other values than those mentioned here, depending on the type of the information recording medium 506 or the like. For example, the wavelength λ of the laser light 502 may be 650 to 670 nm.

Using such a recording/reproducing system, the performances of the information recording medium 506 can be evaluated as follows. Here, both of the performances obtained by a recording method in compliance with the BD format by which the capacity per layer is 25 GB, and the performances obtained by a recording method by which the capacity per layer is raised to 33.4 GB by shortening the shortest mark length, will be described. The wavelength λ of the laser light 502 used for recording/reproduction is in the range of 400 nm to 410 nm, and the NA of the objective lens 504 is in the range of 0.84 to 0.86. Needless to say, any other recording method by which the capacity per layer is different from the above-mentioned capacities is usable, depending on the type of the information recording medium 506 or the like.

The recording performance can be evaluated as follows. The power of the laser light 502 is modulated between 0 and Pp (mV), and random signals corresponding to mark lengths of 2 T to 8 T are recorded by a (1-7) modulation system. Jitter between the leading ends of the recording marks and jitter between the trailing ends of the recording marks (error of the mark positions) are measured by a time interval analyzer. As the value of the jitters is smaller, the recording performance is higher. Pp, Pb, Pc and Pe are determined such that the average value of the jitter between the leading ends and the jitter between the trailing ends is minimum. The optimal Pp value in this case is set as the recording sensitivity. In the case where the capacity per layer is 25 GB, the 2 T mark length and the 8 T mark length are respectively 0.149 μm and 0.596 μm. In the case where the capacity per layer is 33.4 GB, the 2 T mark length and the 8 T mark length are respectively 0.112 μm and 0.447 μm.

The signal strength can be evaluated as follows. The power of the laser light 502 is modulated between 0 and Pp (mW). Signals corresponding to mark lengths of 2 T and 9 T are recorded alternately 10 consecutive times on the same part of the track, and then the 2 T signal is recorded for overwriting. The ratio (Carrier-to-Noise Ratio; CNR) between the carrier level and the noise level at the frequency of the 2 T signal in this case is measured by a spectrum analyzer. As the CNR is higher, the signal strength is higher. In the case where the capacity per layer is 25 GB, the 9 T mark length is 0.671 μm. In the case where the capacity per layer is 33.4 GB, the 9 T mark length is 0.503 μm.

The erasure performance can be evaluated as follows. The power of the laser light 502 is modulated between 0 and Pp (mW). 2 T signals and 9 T signals are recorded alternately 10 consecutive times on the same part of the track, and then the 2 T signal is recorded for overwriting at the 11th time. After this, the 9 T signal is recorded for overwriting. The difference between the carrier level of the 2 T signal after the final 2 T signal recording and the carrier level of the 2 T signal after the final 9 T signal recording is measured by a spectrum analyzer as an erasability of the 2 T signal. As the erasability is higher, the erasure performance is higher.

The upper limit reproduction power is evaluated by reproduction light deterioration. The reproduction light deterioration is defined as the deterioration amount of jitter or error rate obtained when a track having a signal recorded thereon is irradiated with reproduction light (reproduction power: Pr) a prescribed number of times (e.g., one million times). As the reproduction power is higher, the reproduction light deterioration is larger. The maximum value of the power values at which the reproduction deterioration stays within the tolerable value range is the upper limit reproduction power.

### EXAMPLES

Hereinafter, the present invention will be more specifically described by way of examples.

In the example, the information recording medium 11 shown in FIG. 1 was produced. The recording characteristics and the reproduction characteristics of each of the first information layer 41, the second information layer 42 and the third information layer 43 were examined, with the thickness of the recording layer 436 and the thickness of the second dielectric layer 438 of the third information layer 43 being varied. The items measured were the erasability of the third information layer 43 and the reflectance and the upper reproduction power of each information layer.

Samples were produced as follows. First, a polycarbonate substrate (diameter: 120 mm, thickness: 1.1 mm) having a guide groove (depth: 20 nm; track pitch: 0.32 μm) for guiding the laser light 31 was prepared as the substrate 21.

On the polycarbonate substrate, the following layers were sequentially stacked by sputtering: an Ag—Pd—Cu layer (thickness: 80 nm) as the reflection layer 412, a (Zr—O₂)₅₀(In₂O₃)₅₀ layer (thickness: 25 nm) as the first dielectric layer 414, a (GeTe)₉₇(Bi₂Te₃)₃ layer (thickness: 10 nm) as the recording layer, a (ZrO₂)₅₀(Cr₂O₃)₅₀ layer (thickness: 5 nm) as the second interface layer 417 (not shown), and a (ZnS)₈₀(SiO₂)₂₀ layer (thickness: 60 nm) as the second dielectric layer 418.

A film formation apparatus for forming the layers by sputtering includes an Ag—Pd—Cu alloy sputtering target for forming the reflection layer 412, a (Zr—O₂)₅₀(In₂O₃)₅₀ sputtering target for forming the first dielectric layer 414, a (GeTe)₉₇(Bi₂Te₃)₃ sputtering target for forming the recording layer 416, a (ZrO₂)₅₀₁(Cr₂O₃)₅₀ sputtering target for forming the second interface layer 417, and a (ZnS)₈₀(SiO₂)₂₀ sputtering target for forming the second dielectric layer 418. The sputtering targets each have a diameter of 100 mm and a thickness of 6 mm.

The reflection layer 412 was formed in an Ar gas atmosphere at a pressure of 0.3 Pa with a DC power source at a power of 100 W. The first dielectric layer 404 was formed in an Ar gas atmosphere at a pressure of 0.1 Pa with an RF power source at a power of 200 W. The recording layer 406 was formed in an Ar gas atmosphere at a pressure of 0.2 Pa with a DC power source at a power of 50 W. The second interface layer 407 was formed in an Ar gas atmosphere at a pressure of 0.1 Pa with an RF power source at a power of 200 W. The second dielectric layer 408 was formed in an Ar gas atmosphere at a pressure of 0.1 Pa with an RF power source at a power of 400 W.

Then, a UV curable resin was applied to the second dielectric layer 418 and covered with a substrate having a guide groove (depth: 20 nm; track pitch: 0.32 μm). The resultant body was rotated to form a uniform resin layer. After the resin was cured, the substrate was removed. As a result, the separation layer 22 which has a thickness of 25 μm and has a guide groove for guiding the laser light 31 formed in a surface thereof to face the second information layer 42 was obtained.

Then, on the separation layer 22, the following layers were sequentially stacked by sputtering: a TiO₂ layer (thickness: 20 nm) as the transmittance adjusting layer 421, an Ag—Pd—Cu layer (thickness: 10 nm) as the reflection layer 422, a (ZrO₂)₅₀(In₂O₃)₅₀ layer (thickness: 15 nm) as the first dielectric layer 424, a (GeTe)₉₆(Bi₂Te₃)₄ layer (thickness: 7 nm) as the recording layer 426, a (ZrO₂)₅₀(Cr₂O₃)₅₀ layer (thickness: 5 nm) as the second interface layer 427 (not shown), and a (ZnS)₈₀(SiO₂)₂₀ layer (thickness: 40 nm) as the second dielectric layer 428.

A film formation apparatus for forming the layers by sputtering includes a TiO₂ sputtering target for forming the transmittance adjusting layer 421, an Ag—Pd—Cu alloy sputtering target for forming the reflection layer 422, a (Zr—O₂)₅₀(In₂O₃)₅₀ sputtering target for forming the first dielectric layer 424, a (GeTe)₉₇(Bi₂Te₃)₃ sputtering target for forming the recording layer 426, a (ZrO₂)₅₀(Cr₂O₃)₅₀ sputtering target for forming the second interface layer 427, and a (ZnS)₈₀(SiO₂)₂₀ sputtering target for forming the second dielectric layer 428. The sputtering targets each have a diameter of 100 mm and a thickness of 6 mm.

The transmittance adjusting layer 421 was formed in a mixed gas atmosphere of Ar and oxygen (containing oxygen gas at a ratio of 3% with respect to the entirety) at a pressure of 0.3 Pa with an RF power source at a power of 400 W. The reflection layer 422 was formed in an Ar gas atmosphere at a pressure of 0.3 Pa with a DC power source at a power of 100 W. The first dielectric layer 424 was formed in an Ar gas atmosphere at a pressure of 0.1 Pa with an RF power source at a power of 200 W. The recording layer 426 was formed in an Ar gas atmosphere at a pressure of 0.2 Pa with a DC power source at a power of 50 W. The second interface layer 427 was formed in an Ar gas atmosphere at a pressure of 0.1 Pa with an RF power source at a power of 200 W. The second dielectric layer 428 was formed in an Ar gas atmosphere at a pressure of 0.1 Pa with an RF power source at a power of 400 W.

Then, a UV curable resin was applied to the second dielectric layer 428 and covered with a substrate having a guide groove (depth: 20 nm; track pitch: 0.32 μm). The resultant body was rotated to form a uniform resin layer. After the resin was cured, the substrate was removed. As a result, the separation layer 28 which has a thickness of 16 μm and has a guide groove for guiding the laser light 31 formed in a surface thereof to face the third information layer 43 was obtained.

Then, on the separation layer 28, the following layers were sequentially stacked by sputtering: a TiO₂ layer (thickness: 30 nm) as the transmittance adjusting layer 431, an Ag—Pd—Cu layer (thickness: 8 nm) as the reflection layer 432, a (ZrO₂)₅₀(In₂O₃)₅₀ layer (thickness: 10 nm) as the first dielectric layer 434, a (GeTe)₉₆(Bi₂Te₃)₄ layer as the recording layer 436, a (ZrO₂)₅₀(Cr₂O₃)₅₀ layer (thickness: 5 nm) as the second interface layer 437 (not shown), and a (ZnS)₈₀(SiO₂)₂₀ layer as the second dielectric layer 438.

A film formation apparatus for forming the layers by sputtering includes a TiO₂ sputtering target for forming the transmittance adjusting layer 431, an Ag—Pd—Cu alloy sputtering target for forming the reflection layer 432, a (Zr—O₂)₅₀(In₂O₃)₅₀ sputtering target for forming the first dielectric layer 434, a (GeTe)₉₆(Bi₂Te₃)₄ sputtering target for forming the recording layer 436, a (ZrO₂)₅₀(Cr₂O₃)₅₀ sputtering target for forming the second interface layer 437, and a (ZnS)₈₀(SiO₂)₂₀ sputtering target for forming the second dielectric layer 438. The sputtering targets each have a diameter of 100 mm and a thickness of 6 mm.

The transmittance adjusting layer 431 was formed in a mixed gas atmosphere of Ar and oxygen (containing oxygen gas at a ratio of 3% with respect to the entirety) at a pressure of 0.3 Pa with an RF power source at a power of 400 W. The reflection layer 432 was formed in an Ar gas atmosphere at a pressure of 0.3 Pa with a DC power source at a power of 100 W. The first dielectric layer 434 was formed in an Ar gas atmosphere at a pressure of 0.1 Pa with an RF power source at a power of 200 W. The recording layer 436 was formed in an Ar gas atmosphere at a pressure of 0.2 Pa with a DC power source at a power of 50 W. The second interface layer 437 was formed in an Ar gas atmosphere at a pressure of 0.1 Pa with an RF power source at a power of 200 W. The second dielectric layer 438 was formed in an Ar gas atmosphere at a pressure of 0.1 Pa with an RF power source at a power of 400 W.

Finally, a UV curable resin was applied to the second dielectric layer 438 and rotated to form a uniform resin layer. The resin was cured by UV radiation, and thus the transparent layer 23 having a thickness of 59 μm was formed. Then, an initialization step of crystallizing the recording layer 416, the recording layer 436 and the recording layer 436 by laser light was carried out. In this manner, a plurality of samples which are different in the thickness of the recording layer 436 and the thickness of the second dielectric layer 438 of the third information layer 43 were produced.

Regarding the samples of the information recording medium 11 thus obtained, the reflectance and the upper limit reproduction power of each information layer, and the erasability of the third information layer were measured using the recording/reproducing apparatus shown in FIG. 3. The wavelength of the laser light 31 was 405 nm, and the numerical aperture NA of the objective lens 32 was 0.85. The recording was conducted by a recording method by which the capacity per layer is 33.4 GB, and the shortest mark length (2 T) was 0.112 μm. The linear velocity of the samples at the time of recording and measurement was 7.36 m/s.

Regarding each sample, Table 1 shows the thickness of the recording layer 436 and the thickness of the second dielectric layer 438 of the third information layer 43 and the erasure performance of the third information layer 43. The erasure performance is indicated as “∘” when the erasability was 25 dB or higher, and as “×” when the erasability was lower than 25 dB.

TABLE 1

| | Thickness of each layer | | Erasure performance of | |
|---|---|---|---|---|
| | of 3rd information layer | | 3rd information layer | |
| Sample | Recording | 2nd dielectric | Erasability | |
| No. | layer [nm] | layer [nm] | [dB] | Evaluation |
| 1-1 | 5.5 | 40.0 | 19 | X |
| 1-2 | 6.0 | 36.0 | 24 | X |
| 1-3 | 6.5 | 36.0 | 28 | ◯ |
| 1-4 | 6.5 | 32.0 | 28 | ◯ |
| 1-5 | 7.0 | 30.0 | 30 | ◯ |

Regarding each sample, Table 2 shows the thickness of the recording layer 436 and the thickness of the second dielectric layer 438 of the third information layer 43 and the reproduction performance of the first information layer 41. The reproduction performance is indicated as follows. The reflectance and the upper limit reproduction power were first checked. A product of the reflectance and the upper limit reproduction power was defined as the reflected light amount. The reproduction performance is indicated as “∘” when the reflected light amount was 2.2 or higher, and as “×” when the reflected light amount was lower than 2.2.

TABLE 2

| | Thickness of each | | | | | |
|---|---|---|---|---|---|---|
| | layer of 3rd | | Reproduction performance | | | |
| | information layer | | of 1st information layer | | | |
| | Recording | | | Upper limit | Reflected | |
| Sample | layer | 2nd dielectric | Reflectance | reproduction | light | |
| No. | [nm] | layer [nm] | [%] | power [mW] | amount | Evaluation |
| 1-1 | 5.5 | 40.0 | 1.9 | 1.3 | 2.5 | ◯ |
| 1-2 | 6.0 | 36.0 | 1.7 | 1.4 | 2.4 | ◯ |
| 1-3 | 6.5 | 36.0 | 1.6 | 1.4 | 2.2 | ◯ |
| 1-4 | 6.5 | 32.0 | 1.6 | 1.4 | 2.2 | ◯ |
| 1-5 | 7.0 | 30.0 | 1.5 | 1.4 | 2.1 | X |

Regarding each sample, Table 3 shows the thickness of the recording layer 436 and the thickness of the second dielectric layer 438 of the third information layer 43 and the reproduction performance of the second information layer 42. The reproduction performance is indicated as follows. The reflectance and the upper limit reproduction power were first checked. A product of the reflectance and the upper limit reproduction power was defined as the reflected light amount. The reproduction performance is indicated as “∘” when the reflected light amount was 2.2 or higher, and as “×” when the reflected light amount was lower than 2.2.

TABLE 3

| | Thickness of each | | | | | |
|---|---|---|---|---|---|---|
| | layer of 3rd | | Reproduction performance | | | |
| | information layer | | of 2nd information layer | | | |
| | Recording | | | Upper limit | Reflected | |
| Sample | layer | 2nd dielectric | Reflectance | reproduction | light | |
| No. | [nm] | layer [nm] | [%] | power [mW] | amount | Evaluation |
| 1-1 | 5.5 | 40.0 | 2.0 | 1.2 | 2.4 | ◯ |
| 1-2 | 6.0 | 36.0 | 1.8 | 1.3 | 2.3 | ◯ |
| 1-3 | 6.5 | 36.0 | 1.7 | 1.3 | 2.2 | ◯ |
| 1-4 | 6.5 | 32.0 | 1.7 | 1.3 | 2.2 | ◯ |
| 1-5 | 7.0 | 30.0 | 1.6 | 1.3 | 2.1 | X |

Regarding each sample, Table 4 shows the thickness of the recording layer 436 and the thickness of the second dielectric layer 438 of the third information layer 43 and the reproduction performance of the third information layer 43. The reproduction performance is indicated as follows. The reflectance and the upper limit reproduction power were first checked. A product of the reflectance and the upper limit reproduction power was defined as the reflected light amount. The reproduction performance is indicated as “∘” when the reflected light amount was 2.2 or higher, and as “×” when the reflected light amount was lower than 2.2.

TABLE 4

| | Thickness of | | | | | |
|---|---|---|---|---|---|---|
| | each layer of 3rd | | Reproduction performance | | | |
| | information layer | | of 3rd information layer | | | |
| | Recording | | | Upper limit | Reflected | |
| Sample | layer | 2nd dielectric | Reflectance | reproduction | light | |
| No. | [nm] | layer [nm] | [%] | power [mW] | amount | Evaluation |
| 1-1 | 5.5 | 40.0 | 1.6 | 1.3 | 2.1 | X |
| 1-2 | 6.0 | 36.0 | 1.6 | 1.2 | 1.9 | X |
| 1-3 | 6.5 | 36.0 | 2.1 | 1.1 | 2.2 | ◯ |
| 1-4 | 6.5 | 32.0 | 1.6 | 1.1 | 1.8 | X |
| 1-5 | 7.0 | 30.0 | 1.5 | 0.9 | 1.4 | X |

As a summary of the above-mentioned results, Table 5 shows, regarding each sample, the thickness of the recording layer 436 and the thickness of the second dielectric layer 438 of the third information layer 43, the reproduction performance of each information layer, the erasure performance of the third information layer, and the total evaluation based on the reproduction performance and the erasure performance. The total evaluation was given as follows. A sample evaluated as “×” in any one of the items in the above evaluations was evaluated as “×”. A sample evaluated as “∘” in all the items in the above evaluations was evaluated as “⊚”.

A sample evaluated as “⊚” in the total evaluation is practically usable, and a medium evaluated as “×” not practically usable.

TABLE 5

| | Thickness | | | | | | |
|---|---|---|---|---|---|---|---|
| | of each layer of | | | | | | |
| | 3rd information | | Reproduction | | | Erasure | |
| | layer | | performance | | | performance | |
| | Recording | 2nd | 1st | 2nd | 3rd | 3rd | |
| Sample | layer | dielectric | information | information | information | information | Total |
| No. | [nm] | layer [nm] | layer | layer | layer | layer | evaluation |
| 1-1 | 5.5 | 40.0 | ◯ | ◯ | X | X | X |
| 1-2 | 6.0 | 36.0 | ◯ | ◯ | X | X | X |
| 1-3 | 6.5 | 36.0 | ◯ | ◯ | ◯ | ◯ | ⊚ |
| 1-4 | 6.5 | 32.0 | ◯ | ◯ | X | ◯ | X |
| 1-5 | 7.0 | 30.0 | X | X | X | ◯ | X |

Using the above results, Table 6 shows the reflectance, the upper limit reproduction power and the reflected light amount of each layer and the total evaluation of each sample.

TABLE 6

| | | | | | | | | Reflected light | | | |
|---|---|---|---|---|---|---|---|---|---|---|---|
| | | | | | | | | amount | | | |
| | | | | | | | | (reflectance × | | | |
| | | | | | Upper limit | | | upper limit | | | |
| | Reflectance [%] | | | | reproduction | | | reproduction | | | |
| Sample | 1st | 2nd | 3rd | Ratio | power [mW] | | | power) [mW] | | | Total |
| No. | (R1) | (R2) | (R3) | (R3/R2) | 1st | 2nd | 3rd | 1st | 2nd | 3rd | evaluation |
| 1-1 | 1.9 | 2.0 | 1.6 | 0.8 | 1.3 | 1.2 | 1.3 | 2.5 | 2.4 | 2.1 | X |
| 1-2 | 1.7 | 1.8 | 1.6 | 0.9 | 1.4 | 1.3 | 1.2 | 2.4 | 2.3 | 1.9 | X |
| 1-3 | 1.6 | 1.7 | 2.1 | 1.2 | 1.4 | 1.3 | 1.1 | 2.2 | 2.2 | 2.2 | ⊚ |
| 1-4 | 1.6 | 1.7 | 1.6 | 0.9 | 1.4 | 1.3 | 1.1 | 2.2 | 2.2 | 1.8 | X |
| 1-5 | 1.5 | 1.6 | 1.5 | 0.9 | 1.4 | 1.3 | 0.9 | 2.1 | 2.1 | 1.4 | X |

(1st: 1st information layer; 2nd: 2nd information layer; 3rd: 3rd information layer)

As a result, it was found that the information recording medium 11 has good characteristics where the reflectance of the third information layer 43 closest to the laser light 31 incidence side is higher than that of the other information layers and the upper limit reproduction power of the third information layer 43 is lower than that of the other information layers.

It was also found that the information recording medium 11 has good characteristics where the ratio of the reflectance of the third information layer 43 with respect to the reflectance of the second information layer 42 is 1.2 or higher.

It was also found that the information recording medium 11 has good characteristics where the reflected light amount of the third information layer 43 and the reflected light amount of the second information layer 42 are substantially equal to each other.

In this example, the recording layer 426 of the second information layer 42 and the recording layer 436 of the second information layer 43 are formed of the same material. These layers may be formed of different materials in order to adjust the crystallization rate.

An information recording medium and a method for reproducing information from such an information recording medium according to the present invention are useful for improving the quality of information reproduction from an information recording medium including three or more information layers.

1. An information recording medium, comprising N number (N is an integer fulfilling N≧3) of information layers on which information is recordable and allowing information to be recorded to, or reproduced from, each of the information layers by being irradiated with laser light; wherein where the N number of information layers include an Nth information layer, an (N−1)th information layer, an (N−2)th information layer, . . . a second information layer and a first information layer from the side on which the laser light is incident, the Nth information layer has a reflectance of R_{N}, an Mth information layer (M is an integer fulfilling N>M≧1) has a reflectance of R_{M}, the laser light used to irradiate the Nth information layer at the time of information reproduction has an upper limit reproduction power of Pr_{Nmax}, and the laser light used to irradiate the Mth information layer at the time of information reproduction has an upper limit reproduction power of Pr_{Mmax}, the following expressions (1) and (2) are concurrently fulfilled:
R_{N}>R_{M} (1)
Pr_{Nmax}<Pr_{Mmax} (2).

2. The information recording medium of claim 1, wherein a product R_{N}×Pr_{Nmax} of the reflectance R_{N} and the upper limit reproduction power Pr_{Nmax} of the Nth information layer is substantially equal to a product R_{N-1}×Pr_{N-1max} of the reflectance R_{N-1} and the upper limit reproduction power Pr_{N-1max} of the (N−1)th information layer.

3. The information recording medium of claim 1, wherein the reflectance R_{N} of the Nth information layer and the reflectance R_{N-1} of the (N−1)th information layer fulfill the following expression (3):
R_{N}/R_{N-1}≧1.2 (3).

4. The information recording medium of claim 1, wherein:
the Nth information layer and the (N−1)th information layer each include at least a first dielectric layer, a recording layer which is phase-changeable by being irradiated with laser light, a second dielectric layer, and a reflection layer in this order from the side on which the laser light is incident; and
the first dielectric layer, the recording layer, the second dielectric layer, and the reflection layer of the Nth information layer are each formed of the same material as that of a corresponding layer of the (N−1)th information layer.

5. The information recording medium of claim 4, wherein the Nth information layer and the (N−1)th information layer each include a transmittance adjusting layer on a surface of the reflection layer opposite from the side on which the laser light is incident, and the transmittance adjusting layer of the Nth information layer is formed of the same material as that of the transmittance adjusting layer of the (N−1)th information layer.

6. The information recording medium of claim 1, wherein N=3.

7. An information recording medium reproducing method for reproducing information from the information recording medium of claim 1, the method comprising an Nth information layer reproducing method for reproducing information recorded on the Nth information layer at a reproduction power of Pr_{N} (Pr_{N}≦Pr_{Nmax}), and an (N−1)th information layer reproducing method for reproducing information recorded on the (N−1)th information layer at a reproduction power of Pr_{N-1} (Pr_{N-1}≦Pr_{N-1max}), wherein a product R_{N}×Pr_{N} of the reflectance R_{N} and the reproduction power Pr_{N} of the Nth information layer is substantially equal to a product R_{N-1}×Pr_{N-1} of the reflectance R_{N-1} and the reproduction power Pr_{N-1} of the (N−1)th information layer.

8. The information recording medium reproducing method of claim 7, wherein the laser light has a wavelength λ in the range of 400 nm to 410 nm, and an objective lens used for focusing the laser light on each of the information layers has a numerical aperture NA in the range of 0.84 to 0.86.
